(19) United States
(12) Patent Application Publication
(10) Pub. No.: US 2012/0293493 A1
(43) Pub. Date: Nov. 22, 2012

(54) COMPUTER-READABLE STORAGE MEDIUM HAVING DISPLAY CONTROL PROGRAM STORED THEREIN, DISPLAY CONTROL APPARATUS, DISPLAY CONTROL SYSTEM, AND DISPLAY CONTROL METHOD

(75) Inventors: Tomoaki KUROUME, Kyoto (JP); Tetsuya SASAKI, Kyoto (JP); Eiichi SHIRAKAWA, Kyoto (JP)

(73) Assignee: NINTENDO CO., LTD., Kyoto (JP)

(21) Appl. No.: 13/186,811

(22) Filed: Jul. 20, 2011

(30) Foreign Application Priority Data
May 18, 2011 (JP) 2011-111750

(51) Int. Cl. G06T 15/00

(52) U.S. Cl. 345/419

(57) ABSTRACT

In a display control apparatus, contents obtained from a server device are planarly displayed on a screen. Then, in the display control apparatus, an image included in the planarly displayed contents is obtained, and it is determined whether or not the obtained image is a stereoscopically viewable image. When the result of determination is that the obtained image is a stereoscopically viewable image, the image is stereoscopically displayed on the screen.

### CROSS REFERENCE TO RELATED APPLICATION

The disclosure of Japanese Patent Application No. 2011-111750, filed on May 18, 2011, is incorporated herein by reference.

### BACKGROUND OF THE INVENTION

1. Field of the Invention

The present invention relates to a computer readable storage medium having a display control program stored therein, a display control apparatus, a display control system, and a display control method. More particularly, the invention relates to: a computer readable storage medium having stored therein a display control program executed by a computer of a display control apparatus for displaying, on a screen, an image obtained from a server device such as a WEB server; a display control apparatus; a display control system; and a display control method.

2. Description of the Background Art

Display control apparatuses provided in personal computers, mobile telephone terminals, and the like have a so-called WEB browser function, by which a resource obtained by accessing a WEB server is analyzed to display a WEB page including text, images, and the like. The WEB browser function enables a user to view various WEB pages (refer to Japanese Published Patent Publication No. 2010-61504, for example).

On the other hand, various devices for performing stereoscopically viewable display in movies, games, and the like have been proposed. For example, Japanese Laid-Open Patent Publication No. 2004-7395 discloses a technique of taking an image of a virtual 3D space with a virtual stereo camera to generate a left-eye image and a right-eye image, and rendering these images shifted from each other to stereoscopically display a 3D object in the virtual 3D space.

By the way, the conventional WEB server and display control apparatus (a browser engine of the display control apparatus) disclosed in Japanese Published Patent Publication No. 2010-61504 are not configured to deal with a stereoscopically viewable image comprising a left-eye image and a right-eye image as disclosed in Japanese Laid-Open Patent Publication No. 2004-7395. Therefore, even when a stereoscopically viewable image is included in the contents supplied from the WEB server, the image is merely displayed planarly on the screen together with text and the like by the display control apparatus. That is, the display control apparatus cannot identify the image as a stereoscopically viewable image to stereoscopically display the image.

### SUMMARY OF THE INVENTION

Therefore, an object of the present invention is to provide: a computer readable storage medium having stored therein a display control program; a display control apparatus; a display control system; and a display control method, which enable, when a stereoscopically viewable image is included in the contents obtained from a server device, appropriate stereoscopically viewable display of the image.

A computer-readable storage medium according to the present invention is a computer-readable storage medium having stored therein a display control program executed by a computer of a display control apparatus for displaying, on a screen, an image obtained from a server device. The display control program causes the computer to function as first obtaining means, first display control means, second obtaining means, first determination means, and second display control means. The first obtaining means obtains contents including an image from the server device. The first display control means planarly displays, on the screen, the contents obtained by the first obtaining means. The second obtaining means obtains an image included in the contents planarly displayed by the first display control means. The first determination means determines whether or not the image obtained by the second obtaining means is a stereoscopically viewable image. The second display control means stereoscopically displays the image on the screen when the first determination means determines that the obtained image is a stereoscopically viewable image.

After the contents including an image are planarly displayed on the screen, the same image as the image included in the contents is obtained by the second obtaining means. When the image is obtained, the first determination means determines whether or not the image is a stereoscopically viewable image. When the result of determination is that the image is a stereoscopically viewable image, the image is stereoscopically displayed on the screen. In this way, when an image included in the contents is a stereoscopically viewable image, the image is stereoscopically displayed on the screen. Therefore, when the contents obtained from the server device include a stereoscopically viewable image, the image can be appropriately stereoscopically displayed.

An image included in the contents may be obtained from the cache of the display control apparatus. Alternatively, an image included in the contents may be again obtained from the same server device as the server device which provided the image when the contents were obtained.

The second display control means may planarly display the obtained image on the screen when the first determination means determines that the obtained image is not a stereoscopically viewable image.

The display control program may cause the computer to further function as second determination means for determining whether or not a coordinate point, which is designated by coordinate input means on the screen where the contents are displayed, satisfies a predetermined determination condition. In this case, the second obtaining means obtains an image included in the contents when the second determination means determines that the predetermined determination condition is satisfied.

In this configuration, an image included in the contents is obtained when a user operates the coordinate input means (such as a touch panel or a mouse) so that coordinate point on the screen, which is designated by the coordinate input means, satisfies a predetermined determination condition. When the obtained image is a stereoscopically viewable image, the image is stereoscopically displayed on the screen. Therefore, the image can be stereoscopically displayed only when the user performs the operation to stereoscopically display the image. That is, the image can be stereoscopically displayed at a timing desired by the user.

The second determination means may determine, based on the coordinate point designated by the coordinate input means, whether or not a press-and-hold operation is performed onto the image on the screen where the contents are displayed, thereby determining whether or not the coordinate point designated by the coordinate input means satisfies the predetermined determination condition.

The predetermined determination condition may be that a coordinate point is continuously designated over a set period of time, in a predetermined range of the image on the screen where the contents are displayed.

In this configuration, the user can easily view the image as a stereoscopically viewable image by performing, at his/her desired timing, a simple operation of holding the position designated by the coordinate input means so that the coordinate point within the predetermined range of the image is continuously designated over the set period of time.

The first display control means may scroll-display the contents when the coordinate point designated by the coordinate input means gets out of the predetermined range of the image, within the set period of time.

In this configuration, when the user holds the position designated by the coordinate input means, in the predetermined range of the image for a period exceeding the set period of time, the image is obtained. When the image is a stereoscopically viewable image, the image is stereoscopically displayed. On the other hand, when the user moves the designated position in the predetermined range of the image to the outside of the predetermined range, within the set period of time, the contents including the image are scroll-displayed. Therefore, the user can easily select either the stereoscopically viewable display of the image or the scroll display of the contents.

The predetermined determination condition may be that a coordinate point is continuously designated in a predetermined range of the image on the screen where the contents are displayed.

In this configuration, the user can easily view the image as a stereoscopically viewable image by performing, at his/her desired timing, a simple operation of continuously designating a coordinate point in a predetermined range of the image by the coordinate input means so that the coordinate point is continuously designated in the predetermined range of the image.

The second obtaining means may obtain an image included in the contents, from the server device which has provided the first obtaining means with the image included in the contents.

Depending on the configuration of the display control apparatus, an image included in contents cannot easily obtained from the cache of the display control apparatus. The above-described configuration is suitably applicable to such a case.

The second obtaining means may obtain an image included in the contents which have already been obtained by the first obtaining means, again from the server device which has provided the first obtaining means with the image included in the contents.

The first determination means may determine whether or not an image obtained by the second obtaining means is a stereoscopically viewable image, based on whether or not the image obtained by the second obtaining means is composed of a plurality of images.

In this configuration, it is possible to easily determine whether or not the image obtained by the second obtaining means is a stereoscopically viewable image.

The screen may include a first screen capable of planarly viewable display and a second screen capable of stereoscopically viewable display. In this case, the first display control means performs planarly viewable display by using the first screen, and the second display control means performs stereoscopically viewable display by using the second screen.

In this configuration, when the image included in the contents is a stereoscopically viewable image, the image is stereoscopically displayed on the screen different from the screen where the contents are displayed. Therefore, the user can easily recognize that the image is displayed as a stereoscopically viewable image on the screen.

The second display control means may stereoscopically display an image included in the contents, which has been obtained by the second obtaining means, in a size larger than the image included in the contents displayed by the first display control means.

The display control program may cause the computer to further function as storage control means for storing, in storage means, at least a stereoscopically viewable image which is stereoscopically displayed by the second display control means, according to a user input.

In this configuration, since the image stereoscopically displayed on the screen is stored in the storage means, the user can easily view the image later.

The present invention may be regarded as a display control apparatus for displaying, on a screen, an image obtained from a server device. The display control apparatus includes first obtaining means, first display control means, second obtaining means, first determination means, and second display control means. The first obtaining means obtains contents including an image from the server device. The first display control means planarly displays, on the screen, the contents obtained by the first obtaining means. The second obtaining means obtains an image included in the contents planarly displayed by the first display control means. The first determination means determines whether or not the image obtained by the second obtaining means is a stereoscopically viewable image. The second display control means stereoscopically displays the image on the screen when the first determination means determines that the obtained image is a stereoscopically viewable image.

The present invention may be regarded as a display control system for displaying, on a screen, an image obtained from a server device. The display control system includes first obtaining means, first display control means, second obtaining means, first determination means, and second display control means. The first obtaining means obtains contents including an image from the server device. The first display control means planarly displays, on the screen, the contents obtained by the first obtaining means. The second obtaining means obtains an image included in the contents planarly displayed by the first display control means. The first determination means determines whether or not the image obtained by the second obtaining means is a stereoscopically viewable image. The second display control means stereoscopically displays the image on the screen when the first determination means determines that the obtained image is a stereoscopically viewable image.

The present invention may be regarded as a display control method for displaying, on a screen, an image obtained from a server device. In this display control method, firstly, contents including an image are obtained from the server device. Then, the obtained contents are planarly displayed on the screen. Thereafter, an image included in the planarly displayed contents is obtained, and it is determined whether or not the obtained image is a stereoscopically viewable image. When the result of determination is that the obtained image is a stereoscopically viewable image, the image is stereoscopically displayed on the screen.

According to the present invention, when an image included in the contents is a stereoscopically viewable image, the image is stereoscopically displayed on the screen. Therefore, when a stereoscopically viewable image is included in the contents obtained from the server device, the image can be appropriately stereoscopically displayed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in its opened state;

FIG. 2A is a left side view of the game apparatus 10 in its closed state;

FIG. 2B is a front view of the game apparatus 10 in its closed state;

FIG. 2C is a right side view of the game apparatus 10 in its closed state;

FIG. 2D is a rear view of the game apparatus 10 in its closed state;

FIG. 3 is a block diagram illustrating an internal configuration of the game apparatus 10;

FIG. 4 is a diagram illustrating a configuration of a network system 500;

FIG. 5 is a diagram illustrating scroll display of a WEB page;

FIG. 6A is a diagram illustrating a state where an image in a WEB page which is planarly displayed on a lower LCD 12 is selected;

FIG. 6B is a diagram illustrating a state where the selected image is stereoscopically displayed on an upper LCD 22;

FIG. 7 is a memory map of a main memory 32;

FIG. 8 is a flowchart illustrating an example of a main process executed based on a browser engine 322 in the game apparatus 10; and

FIG. 9 is a flowchart illustrating, in detail, an image display process in step S13 in FIG. 8, which is executed based on an image display processing program 323 in the game apparatus 10.

### DESCRIPTION OF THE PREFERRED EMBODIMENTS

Hereinafter, an embodiment of the present invention will be described with reference to drawings as necessary.

[Configuration of Game Apparatus 10]

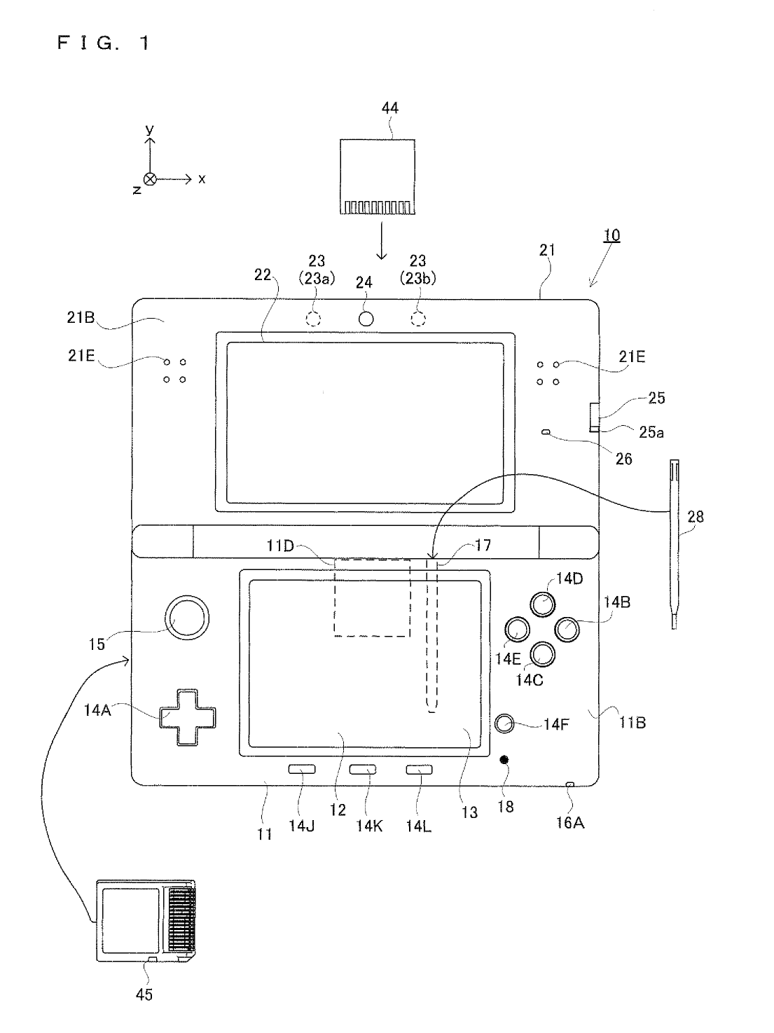

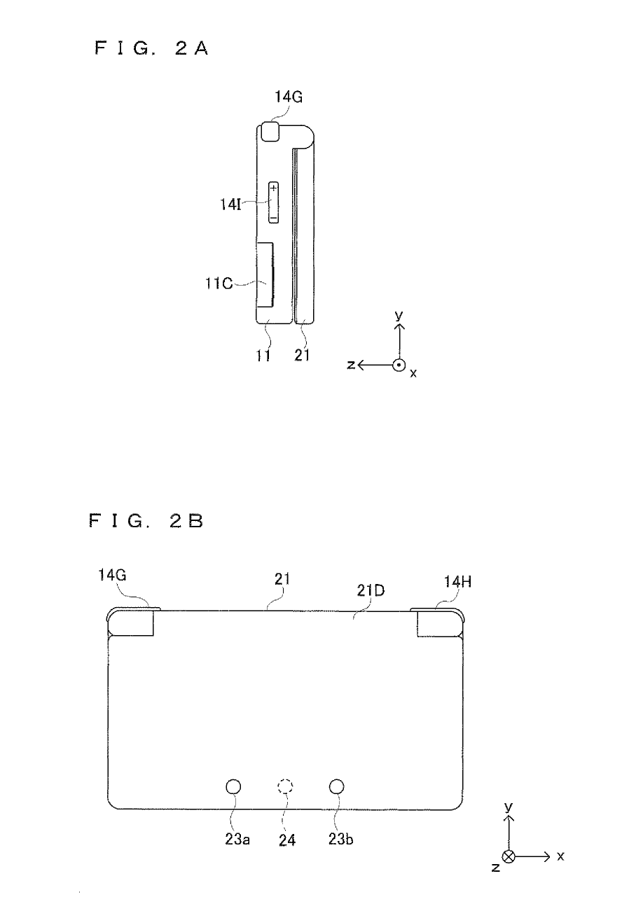

Firstly, a game apparatus 10 typifying a display control apparatus according to one embodiment of the present invention will be described. The game apparatus 10 is a hand-held game apparatus. As shown in FIG. 1, and FIGS. 2A to 2D, the game apparatus 10 includes a lower housing 11 and an upper housing 21. The lower housing 11 and the upper housing 21 are connected to each other so as to be openable and closable (foldable).

[Description of Lower Housing 11]

As shown in FIG. 1, and FIGS. 2A to 2D, the lower housing 11 is provided with a lower LCD (Liquid Crystal Display) 12, a touch panel 13, operation buttons 14A to 14L, an analog stick 15, an LED 16A and an LED 16B, an insertion opening 17, and a microphone hole 18.

The touch panel 13 is mounted on the lower LCD 12, and functions as a coordinate input means. In the present embodiment, the touch panel 13 is a resistive film type touch panel. However, another pressing type touch panel, such as an electrostatic capacitance type touch pane, may be used. The insertion opening 17 (indicated by dashed line in FIG. 1 and FIG. 2D) is provided on the upper side surface of the lower housing 11 for accommodating a touch pen 28.

A cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11.

The analog stick 15 is a device for indicating a direction.

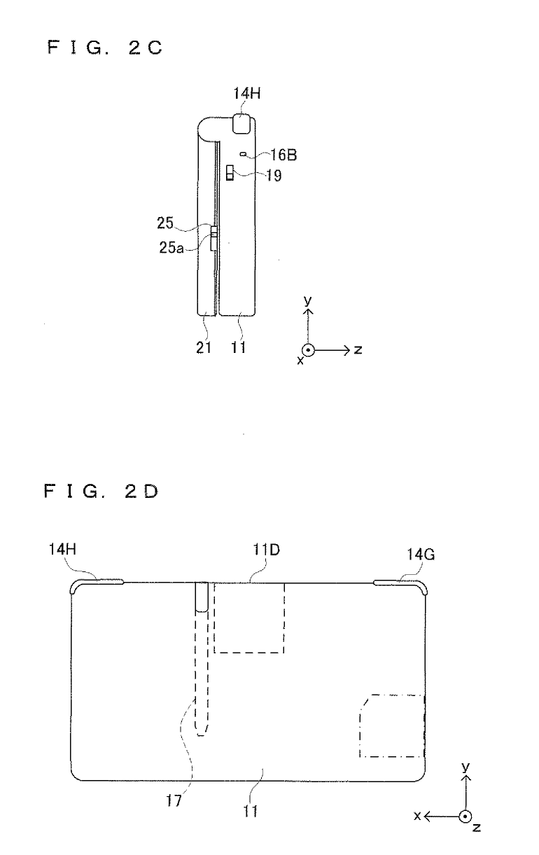

The microphone hole 18 is provided on the inner side surface of the lower housing 11. Under the microphone hole 18, a microphone 42 (see FIG. 3) is provided as a sound input device described below.

As shown in FIG. 2B and FIG. 2D, the L button 14G and the R button 14H are provided on the upper side surface of the lower housing 11. As shown in FIG. 2A, a sound volume button 14I is provided on the left side surface of the lower housing 11 for adjusting a sound volume of a speaker 43 (shown in FIG. 3) of the game apparatus 10.

As shown in FIG. 2A, a cover section 11C is provided on the left side surface of the lower housing 11 so as to be openable and closable. Inside the cover section 11C, a connector is provided for electrically connecting between the game apparatus 10 and an external data storage memory 45.

As shown in FIG. 2D, an insertion opening 11D through which an external memory 44 is inserted is provided on the upper side surface of the lower housing 11.

As shown in FIG. 1 and FIG. 2C, a first LED 16A for notifying a user of an ON/OFF state of a power supply of the game apparatus 10 is provided on the lower side surface of the lower housing 11. A second LED 16B for notifying a user of an establishment state of a wireless communication of the game apparatus 10 is provided on the right side surface of the lower housing 11. The game apparatus 10 can make wireless communication with other devices, and a wireless switch 19 for enabling/disabling the function of the wireless communication is provided on the right side surface of the lower housing 11 (see FIG. 2C).

[Description of Upper Housing 21]

As shown in FIG. 1 and FIG. 2, the upper housing 21 is provided with an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26.

The upper LCD 22 is a display device capable of displaying a stereoscopically viewable image. Specifically, the upper LCD 22 is a display device which allows a user to view a stereoscopic image with her/his naked eyes by utilizing parallax barrier. The upper LCD 22 allows a user to view an image for a left eye with her/his left eye, and an image for a right eye with her/his right eye by utilizing a parallax barrier, so that a stereoscopic image (stereoscopically viewable image) exerting a stereoscopic effect for a user can be displayed. Further, the upper LCD 22 may disable the parallax barrier. When the parallax barrier is disabled, an image can be displayed in a planar manner. Thus, the upper LCD 22 is a display device capable of switching between a stereoscopic display mode for displaying a stereoscopically viewable image and a planar display mode for displaying an image in a planar manner (for displaying a planar view image). The switching of the display mode is performed by means of, for example, the 3D adjustment switch 25 described below.

Two imaging sections (23a and 23b) provided on the outer side surface 21D of the upper housing 21 are generically referred to as the outer imaging section 23. The outer imaging section (left) 23a and the outer imaging section (right) 23b can be used as a stereo camera according to a program executed by the game apparatus 10.

The inner imaging section 24 is positioned on the inner side surface 21B of the upper housing 21, and acts as an imaging section which has an imaging direction which is the same direction as the inward normal direction of the inner side surface.

The 3D adjustment switch 25 is a slide switch, and is used for switching a display mode of the upper LCD 22 as described above. The 3D adjustment switch 25 is used for adjusting the stereoscopic effect of a stereoscopically viewable image (stereoscopic image) which is displayed on the upper LCD 22. A slider 25a of the 3D adjustment switch 25 can be slid to any position in a predetermined direction (upward/downward direction), and a display mode of the upper LCD 22 is determined according to the position of the slider 25a. Further, the viewable manner for the stereoscopic image is adjusted according to the position of the slider 25a.

The 3D indicator 26 is implemented as LEDs for indicating whether the upper LCD 22 is in the stereoscopic display mode.

Further, a speaker hole 21E is provided on the inner side surface of the upper housing 21. Sound is outputted through the speaker hole 21E from the speaker 43 described below.

[Internal Configuration of Game Apparatus 10]

Next, an internal electrical configuration of the game apparatus 10 will be described with reference to FIG. 3. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, a power supply circuit 40, an interface circuit (I/F circuit) 41, and the like.

The information processing section 31 includes: a CPU (Central Processing Unit) 311 for executing a predetermined program; a GPU (Graphics Processing Unit) 312 for performing image processing; and a VRAM (Video RAM) 313. The CPU 311 executes a program stored in a memory (for example, the external memory 44 connected to the external memory I/F 33, or the internal data storage memory 35) in the game apparatus 10, to execute a process based on the program. The program executed by the CPU 311 may be obtained from another device through communication with the other device. The GPU 312 generates an image according to an instruction from the CPU 311, and renders the image in the VRAM 313. The image rendered in the VRAM 313 is outputted to the upper LCD 22 and/or the lower LCD 12, and the image is displayed on the upper LCD 22 and/or the lower LCD 12.

The external memory I/F 33 is an interface for detachably connecting to the external memory 44. The external data storage memory I/F 34 is an interface for detachably connecting to the external data storage memory 45.

The main memory 32 is volatile storage device used as a work area and a buffer area for (the CPU 311 of) the information processing section 31.

The external memory 44 is non-volatile storage device for storing, for example, a program executed by the information processing section 31. The external memory 44 is implemented as, for example, a read-only semiconductor memory.

The external data storage memory 45 is implemented as a non-volatile readable and writable memory (for example, a NAND flash memory), and is used for storing any data.

The internal data storage memory 35 is implemented as a non-volatile readable and writable memory (for example, a NAND flash memory), and is used for storing predetermined data. For example, data and/or programs downloaded through the wireless communication module 36 by wireless communication are stored in the internal data storage memory 35.

The wireless communication module 36 has a function of connecting to a wireless LAN by using a method compliant with, for example, IEEE 802.11.b/g standard. The local communication module 37 has a function of performing wireless communication with the same type of game apparatus in a predetermined communication method (for example, a communication based on an independent protocol, or infrared communication).

The acceleration sensor 39 detects magnitudes of accelerations (linear accelerations) in the directions of the straight lines along the three axial (xyz axial) directions, respectively. The information processing section 31 can receive data (acceleration data) representing accelerations detected by the acceleration sensor 39, and detect an orientation and a motion of the game apparatus 10.

The RTC 38 counts time and outputs the counted time to the information processing section 31. The information processing section 31 calculates a current time (date) based on the time counted by the RTC 38. The power supply circuit 40 controls power to be supplied from a power supply (the rechargeable battery) of the game apparatus 10, and supplies power to each component of the game apparatus 10.

The touch panel 13, the microphone 42, and the speaker 43 are connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The information processing section 31 obtains the touch position data to recognize a position at which an input on the touch panel 13 is made.

The operation button 14 includes the operation buttons 14A to 14L described above. Operation data representing an input state of each of the operation buttons 14A to 14I is outputted from the operation button 14 to the information processing section 31, and the input state indicates whether or not each of the operation buttons 14A to 14I has been pressed.

The lower LCD 12 and the upper LCD 22 are connected to the information processing section 31. Specifically, the information processing section 31 is connected to an LCD controller (not shown) of the upper LCD 22, and causes the LCD controller to set the parallax barrier to ON or OFF. When the parallax barrier is set to ON in the upper LCD 22, a right-eye image and a left-eye image, which are stored in the VRAM 313 of the information processing section 31, are outputted to the upper LCD 22. More specifically, the LCD controller alternately repeats reading of pixel data of the right-eye image for one line in the vertical direction, and reading of pixel data of the left-eye image for one line in the vertical direction, thereby reading, from the VRAM 313, the right-eye image and the left-eye image. Thus, an image to be displayed is divided into the right-eye images and the left-eye images each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the right-eye image is viewed by the user's right eye, and the left-eye image is viewed by the user's left eye. Thus, the stereoscopically viewable image is displayed on the screen of the upper LCD 22.

The outer imaging section 23 and the inner imaging section 24 each take an image according to an instruction from the information processing section 31, and data of the taken images are outputted to the information processing section 31.

The 3D adjustment switch 25 transmits, to the information processing section 31, an electrical signal based on the position of the slider 25a.

The information processing section 31 controls whether or not the 3D indicator 26 is to be lit up. For example, the information processing section 31 lights up the 3D indicator 26 when the upper LCD 22 is in the stereoscopic display mode.

The configuration of the hardware described above is only an exemplary configuration. The configuration of the game apparatus 10 may be modified as necessary.

[Configuration of Network System 500]

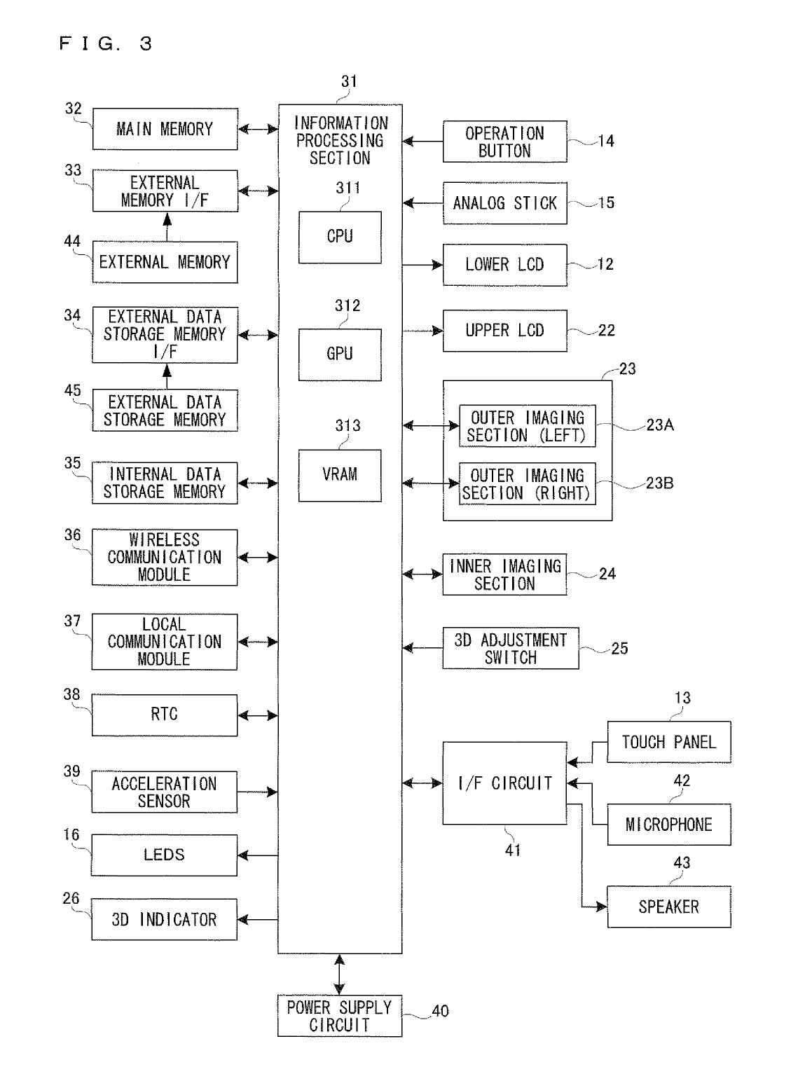

FIG. 4 is a diagram illustrating a network system 500 constituted by game apparatuses 10 (10A, 10B, and 10C) and a WEB server 100. As shown in FIG. 4, each game apparatus 10 is communicably connected to the WEB server 100 (an example of a server device) via the Internet.

The WEB server 100 is configured to execute an application program for performing communication in conformity with HTTP (Hyper Text Transfer Protocol). Based on the application program, the WEB server 100 returns, to the game apparatus 10, resources such as HTML text and images described by HTML (Hyper Text Markup Language), in response to a connection request from the game apparatus 10.

The game apparatus 10 is equipped with protocols such as HTTP and a WEB browser, and is connectable to a network such as the Internet via the wireless communication module 36. Therefore, the game apparatus 10 is allowed to obtain, from the WEB server 100 or the like, the HTML text, images, and the like published on the network, and display the same.

Although FIG. 4 shows a state where three game apparatuses 10 and one WEB server 100 are communicably connected, the number of game apparatuses 10 and the number of WEB servers 100, which constitute the network system 500, are not particularly limited. Further, in the present embodiment, the network system 500 is a computer network system constructed by utilizing the Internet. However, the network system 500 may be constructed by utilizing a computer network such as LAN. That is, the server device is not limited to the WEB server 100, and any server may be adopted so long as it has a function of transmitting contents (HTML text, images, and the like) to the game apparatus 10.

[Outline of Contents Display Process]

The following will describe the outline of a process of displaying contents in the game apparatus 10. In the game apparatus 10, a program, which is loaded from the external memory 44 or the internal data storage memory 35 to the main memory 32, is executed by a CPU 311 of the information processing section 31. Thereby, a user is allowed to freely scroll a WEB page displayed on the lower LCD 12 by means of the touch panel 13. In addition, the user is allowed to select an image in a WEB page planarly displayed on the lower LCD 12, and stereoscopically display the image on the upper LCD 22.

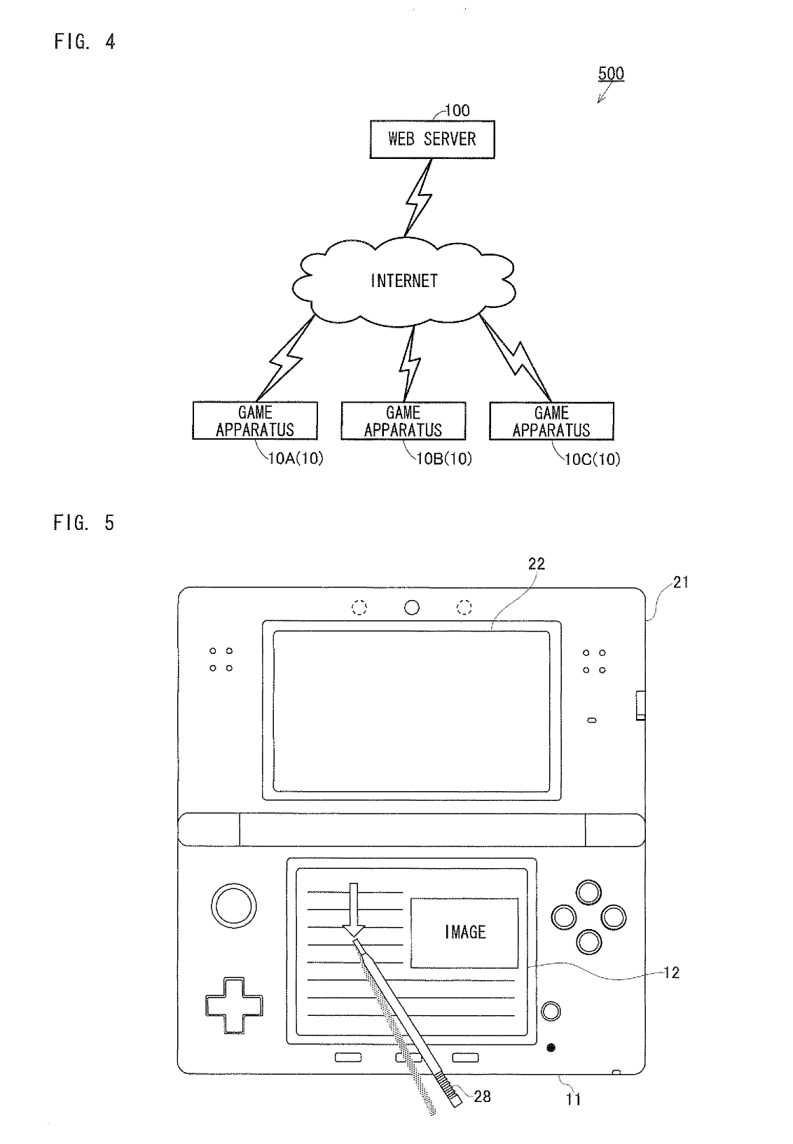

FIG. 5 is a diagram illustrating scroll display of a WEB page. As shown in FIG. 5, a WEB page including contents such as HTML text and images is displayed on the lower LCD 12. In this state, if the user touches, with the touch pen 28, an arbitrary position on the WEB page, and slides the touch pen 28, the WEB page is scroll-displayed by an amount corresponding to the amount of sliding of the touch pen 28. Although in FIG. 5 the touch pen 28 is slid downward and the WEB page is scrolled downward, the scroll direction of the WEB page is not limited thereto.

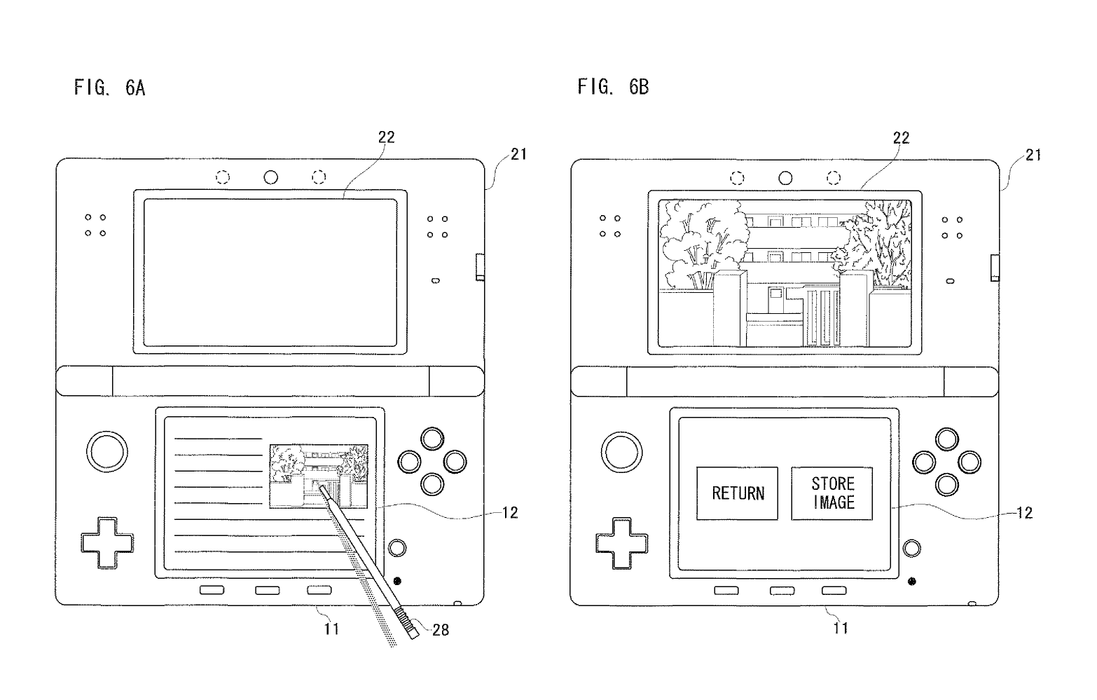

FIGS. 6A and 6B are diagrams illustrating a process from when an image is planarly displayed on the lower LCD 12 to when the image is stereoscopically displayed on the upper LCD 22. Specifically, FIG. 6A is a diagram illustrating a manner in which an image in a WEB page, which is planarly displayed on the lower LCD 12, is selected. FIG. 6B is a diagram illustrating a state where the selected image is stereoscopically displayed on the upper LCD 22. When a user performs an operation to specify a WEB page, the WEB page is planarly displayed on the lower LCD 12 as shown in FIG. 6A. At this time, even if the WEB page includes a stereoscopically viewable image, the WEB page is planarly displayed on the lower LCD 12. This WEB page contains, as a part of various contents, an image having no hyperlink embedded therein. If a position corresponding to this image on the touch panel 13 is touched with the touch pen 28 for a period longer than a set period of time (e.g., 2 seconds), the image is obtained, and then it is determined whether or not the image is a stereoscopically viewable image. If the image is a stereoscopically viewable image, the image is stereoscopically displayed on the upper LCD 22 (refer to FIG. 6B). The stereoscopically viewable image is full-screen displayed on the upper LCD 22. That is, the image is stereoscopically displayed in a larger size as compared to the image having been planarly displayed as a part of the contents. At this time, a button for returning to display of the WEB page and a button for storing the content of the stereoscopically viewable image are displayed on the lower LCD 12. The user is allowed to display the WEB page again or store the content of the stereoscopically viewable image in the main body of the game apparatus 10 (e.g., the external data storage memory 45) by pointing either of the buttons with the touch pen 28. This process is performed when a stereoscopically viewable image generated in the game apparatus 10 is uploaded to the WEB server 100, and a WEB page including the stereoscopically viewable image is published.

In the following description, touching the touch panel 13 with the touch pen 28 is referred to as “touch on”, and moving the touch pen 28 away from the touch panel 13 is referred to as “touch off”. A position where the touch pen 28 touches on the touch panel 13 is referred to as “touch-on position”, and a position on the touch panel 13, which has lately been touched with the touch pen 28 before “touch off” of the touch pen 28, is referred to as “touch-off position”.

[Memory Map]

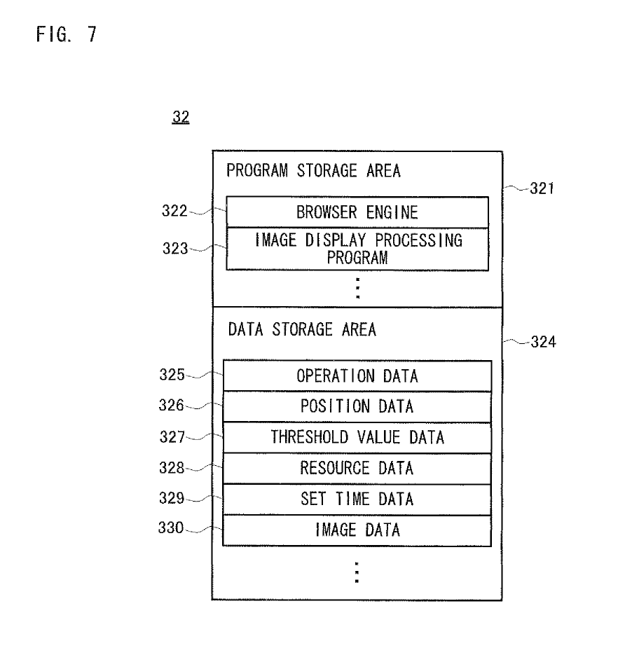

Hereinafter, data stored in the main memory 32 will be described with reference to FIG. 7. FIG. 7 shows a memory map of the main memory 32. As illustrated in FIG. 7, the main memory 32 includes a program storage area 321 and a data storage area 324. In the program storage area 321, display control programs to be executed by the CPU 311 is stored. In the data storage area 324, various data are stored, which are necessary for a process of displaying HTML text and images. The programs in the program storage area 321 and a portion of data in the data storage area 324 are previously stored in the external memory 44 or the internal data storage memory 35, and are loaded into the main memory 32 when a WEB page is displayed.

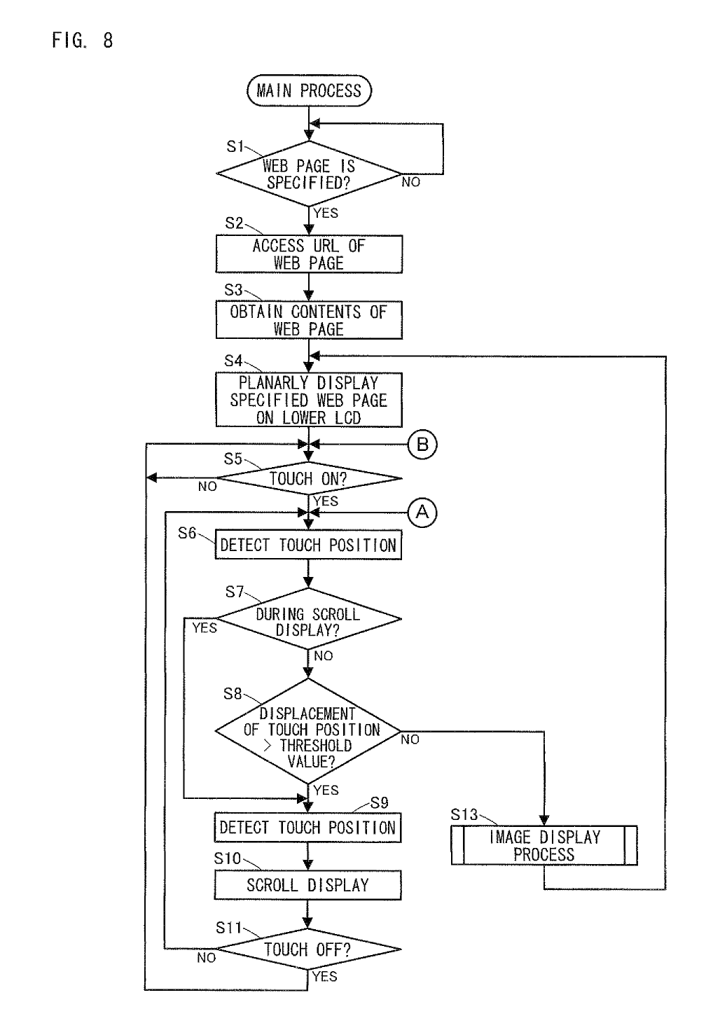

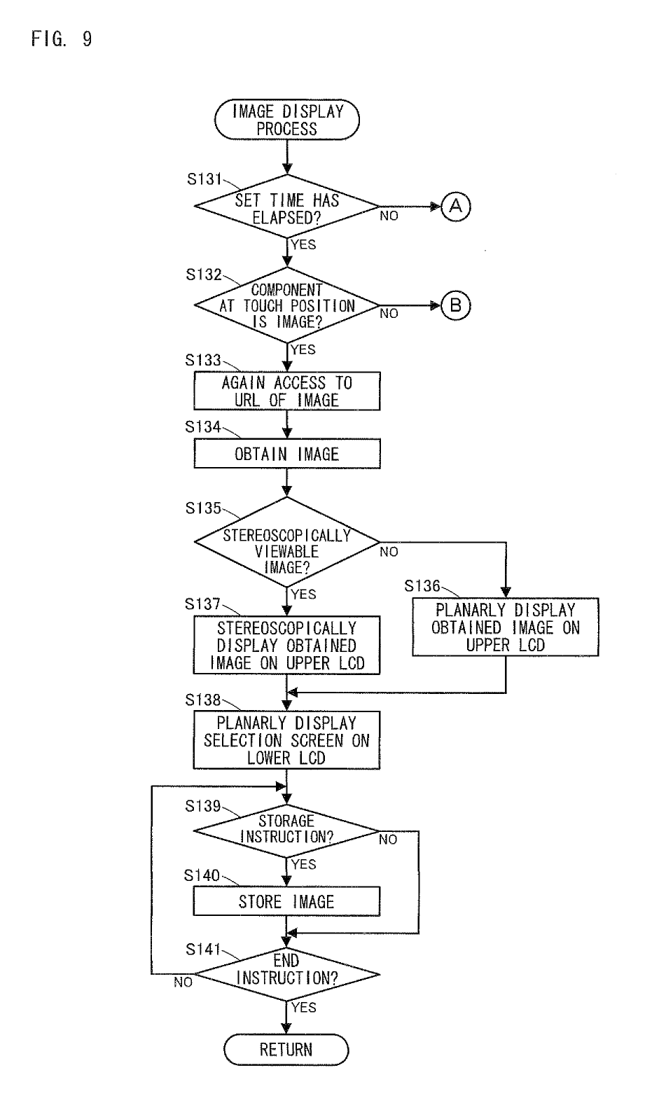

In the program storage area 321, a browser engine 322, an image display processing program 323, and the like are stored as the display control programs. The browser engine 322 has functions similar to those of general browser engines, and causes the information processing section 31 to execute a series of process steps shown in the flowchart of FIG. 8. The image display processing program 323 causes the information processing section 31 to execute a series of process steps shown in the flowchart of FIG. 9.

The browser engine 322, in conformity with HTTP, transmits a connection request to the WEB server 100, and analyzes a resource returned from the WEB server 100. Based on the result of analysis, the browser engine 322 causes the information processing section 31 to execute a process of planarly displaying a WEB page including HTML text and images on the lower LCD 12. Further, the browser engine 322 causes the information processing section 31 to execute a process instructed by means of the touch panel 13 (e.g., scroll display of the WEB page, or a request, to the WEB server 100, for a resource from a link destination specified by a hyperlink address).

The browser engine 322 has a function of operating in cooperation with the image display processing program 323 which is a program other than the browser engine 322. Specifically, when a selection operation to an image in a WEB page is performed, processes based not on the browser engine 322 but on the image display processing program 323 are executed by the information processing section 31.

The image display processing program 323 causes the information processing section 31 to execute a process of determining whether or not the time elapsed from when a coordinate point on an image in the touch panel 13 is touched with the touch pen 28 exceeds a set period of time. That is, the image display processing program 323 causes the information processing section 31 to execute a process of determining whether or not a press-and-hold operation by the touch pen 28 onto the image in the WEB page planarly displayed on the lower LCD 12 has been performed. When such a press-and-hold operation onto the image has been performed, the image display processing program 323 causes the information processing section 31 to execute processes of: obtaining the image; determining whether or not the image is a stereoscopically viewable image; stereoscopically displaying the image on the upper LCD 22 when the image is a stereoscopically viewable image; and planarly displaying the image on the lower LCD 12 when the image is a planarly viewable image.

While the outline of the process based on the browser engine 322 and the image display processing program 323 has been described above, the details of the process executed by the information processing section 31 based on the browser engine 322 and the image display processing program 323 will be described later with reference to FIGS. 8 and 9.

In the data storage area 324, operation data 325, position data 326, threshold value data 327, resource data 328, set time data 329, and image data 330, and the like are stored.

The operation data 325 represents an operation performed by a user on any one of the operation buttons 14A to 14E and 14G to 14H, the analog stick 15, and the touch, panel 13. Based on operation information represented by the operation data 325, a process of determining whether or not a WEB page is specified is performed.

The position data 326 represents a touch position (designated position) on the touch panel 13 by the touch pen 28. While the WEB page is being displayed, a process of determining whether or not an operation to select an image in the WEB page (in the present embodiment, a press-and-hold operation onto an image by the touch pen 28) is performed, and a process of determining whether or not execution of scroll display of the WEB page is instructed, are performed based on a touch position represented by the position data 326.

The threshold value data 327 represents a threshold value used for the process of determining whether or not execution of scroll display of a WEB page is instructed. The determination process based on the threshold value data 327 will be described later in detail.

The resource data 328 represents resources constituting a WEB page, such as HTML text and images.

The set time data 329 represents a preset period of time which is used for a process (step S131 described later) of determining whether or not a press-and-hold operation has been performed onto an image in a WEB page which is planarly displayed on the lower LCD 12.

The image data 330 is data of an image to be obtained when a press-and-hold operation is performed onto the image in a WEB page. The image data 330 is data of the same image as the image in the WEB page which is planarly displayed on the lower LCD 12. In the present embodiment, the image data 330 is obtained by again accessing the WEB server 100 from the game apparatus 10 after the WEB page is displayed on the lower LCD 12.

It should be noted that such as image data (not shown) obtained by image taking by the outer imaging section 23 or the inner imaging section 24 is also stored in the data storage area 324. Such data is not directly related to the present invention, and the detailed description thereof is not given in the present embodiment.

[Description of Main Process by Browser Engine 322]

The following will describe, with reference to FIG. 8, a main process to be executed by the game apparatus 10 based on the browser engine 322. FIG. 8 is a flowchart illustrating an example of a main process to be executed based on the browser engine 322 in the game apparatus 10.

Firstly, the CPU 311 determines, based on operation information represented by the operation data 325, whether or not a WEB page a user desires to view is specified (step S1). When the CPU 311 determines that the WEB page is not specified (NO in step S1), the process returns to step S1.

When the CPU 311 determines that the WEB page is specified (YES in step S1), the CPU 311 transmits a connection request to the WEB server 100, and accesses the URL of the specified WEB page (step S2). Then, the CPU 311 receives a resource transmitted from the WEB server 100 to obtain the resource of the WEB page (step S3). That is, the CPU 311 obtains contents including an image from the WEB server 100. The resource obtained in the process of step S3 is stored as resource data 328 in the data storage area 324. Further, the URL of the image included in the contents is stored in the data storage area 324.

Next, the CPU 311 analyzes the resource represented by the resource data 328. Then, based on the result of analysis, the CPU 311 planarly displays, on the lower LCD 12, the WEB page including the contents such as HTML text, images, and the like (step S4).

After the WEB page is planarly displayed on the lower LCD 12, the CPU 311 determines, based on touch position data supplied from the touch panel control circuit in the I/F circuit 41, whether or not the touch pen 28 touches on the touch panel 13 (step S5). When the CPU 311 determines that the touch pen 28 does not touch on the touch panel 13 (NO in step S5), the process returns to step S5.

When the CPU 311 determines that the touch pen 28 touches on the touch panel 13 (YES in step S5), the CPU 311 detects, based on the touch position data, a touch position which is touched by the touch pen 28 on the touch panel 13 (step S6). In the present embodiment, the horizontal direction and the vertical direction of the screen of the lower LCD 12 are the X-axis direction and the Y-axis direction, respectively, and a touch position is represented by two-dimensional coordinates (X, Y). In this way, the CPU 311 detects, as a touch position, a position on the screen of the lower LCD 12, which is designated on the touch panel 13 by the touch pen 28, and stores the result of detection as position data 326 in the data storage area 324.

Subsequently to the process of step S6, the CPU 311 determines, based on the information stored in the data storage area 324, whether or not the WEB page planarly displayed on the lower LCD 12 is being scroll-displayed (step S7). When the CPU 311 determines that the WEB page is being scroll-displayed (YES in step S7), the process goes to step S9 described later.

On the other hand, when the result of determination is that the WEB page is not being scroll-displayed (NO in step S7), the CPU 311 determines whether or not a displacement of the touch position exceeds a preset threshold value (step S8). Specifically, the CPU 311 determines whether or not a displacement of the touch position (a displacement from the touch-on position to the current touch position), which is represented by the position data 326, exceeds the threshold value represented by the threshold value data 327.

When the result of determination is that the displacement of the touch position exceeds the threshold value (YES in step S8), the CPU 311 determines that the user instructs scroll of the WEB page, and executes the following processes. That is, the CPU 311 detects a touch position (step S9) as in step S6. Then, the CPU 311 scroll-displays the entire WEB page (step S10). Specifically, the CPU 311 determines a scroll direction (a direction from two-dimensional coordinates (X1, Y1) to two-dimensional coordinates (X1, Y2)) based on the two-dimensional coordinates (X1, Y1) of the touch position obtained in step S6 and the two-dimensional coordinates (X1, Y2) of the touch position obtained in step S9. Then, the CPU 311 determines a scroll width corresponding to the distance between the two two-dimensional coordinates (the amount of movement of the WEB page on the screen of the lower LCD 12). Thereafter, the CPU 311 scroll-displays the WEB page on the screen of the lower LCD 12, by the determined scroll width, along the determined scroll direction, as described with reference to FIG. 5.

As described above, when the touch position is moved from a point (starting point) on an arbitrary content by a user's drag operation (an operation to slide the touch pen 28), the CPU 311 scroll-displays the WEB page so that the WEB page moves by the scroll width corresponding to the amount of movement of the touch position, along the direction in which the touch position is moved, regardless of the type of the component at the touch position. That is, even when the user performs a drag operation not on a text but on an image, it is possible to scroll-display the WEB page.

Subsequently to the process of step S10, the CPU 311 determines whether or not the touch pen 28 is moved away from the touch panel 13 (touch off), based on presence/absence of touch position data from the touch panel control circuit (step S11). When the CPU 311 determines that the touch pen 28 is not moved away from the touch panel 13 (NO in step S11), the process returns to step S6. On the other hand, when the CPU 311 determines that the touch pen 28 is moved away from the touch panel 13 (YES in step S11), the process returns to step S5.

On the other hand, when the CPU 311 determines that the displacement of the touch position does not exceed the threshold value (NO in step S8), the CPU 311 calls the image display processing program 323, and executes an image display process based on the image display processing program 323 (step S13).

[Description of Image Display Process by Image Display Processing Program 323]

The following will describe, with reference to FIG. 9, an image display process to be executed by the game apparatus 10 based on the image display processing program 323 when a press-and-hold operation onto the touch panel 13 is performed. FIG. 9 is a flowchart specifically illustrating the image display process of step S13 in FIG. 8.

When the result of determination is that the displacement of the touch position does not exceed the threshold value (NO in step S8), the CPU 311 determines whether or not a set period of time has elapsed from the “touch-on” to the touch panel 13 (step S131). Specifically, the CPU 311 determines whether or not the time elapsed from the “touch-on” to the touch panel 13 exceeds the set period of time (e.g., 2 seconds) represented by the set time data 329.

When the CPU 311 determines that the set period of time has not yet elapsed (NO in step S131), the process returns to step S6. Therefore, if the displacement of the touch position exceeds the threshold value within the set period of time, scroll display of the WEB page is performed.

On the other hand, when the result of determination is that the set period of time has elapsed from the “touch-on” (YES in step S131), the CPU 311 determines whether or not the component at the touch position is an image (step S132). Specifically, the CPU 311 determines whether or not the component at the touch position is an image, based on whether or not the touch position on the touch panel 13, which is represented by the position data 326, is included in an area on the touch panel 13, which corresponds to the display area of the image on the lower LCD 12.

As described above, through the processes of steps S8, S131, and S132, the CPU 311 determines whether or not a coordinate point in an image, which is designated by means of the touch panel 13 on the lower LCD 12 on which a WEB page including contents such as images is displayed, has been continuously designated over a set period of time.

When the CPU 311 determines in step S132 that the component at the touch position is not an image (NO in step S132), the image display process by the image display processing program 323 is ended, and the process returns to step S5 which is performed by the browser engine 322.

On the other hand, when the CPU 311 determines that the component at the touch position is an image (YES in step S132), the CPU 311 again accesses the URL of the image (step S133). Specifically, the CPU 311 accesses the URL of the image stored in the data storage area 324 in step S3 to obtain the image selected by the user's press-and-hold operation (step S134). The image obtained in step S134 is stored as image data 330 in the data storage area 324. If only images included in contents are stored in a server device different from the server device 100 in which the contents are stored, an image is obtained from the different server device.

As described above, when the CPU 311 determines that a predetermined determination condition is satisfied, the CPU 311 obtains an image included in the contents in the WEB page from the WEB server 100 which provides the image included in the contents. In the present embodiment, the determination condition is that a coordinate point in a range of an image on the touch panel 13, which range is determined by a threshold value represented by the threshold value data 327, has been designated over a set period of time. It should be noted that even if the touch position in the image on the touch panel 13 is slightly displaced, it is considered that the same coordinate point in the image on the touch panel 13 has been continuously designated, so long as the displacement does not exceed the threshold value represented by the threshold value data 327.

The image obtained in the process of step S134 is identical to the image obtained in the process of step S3 by the browser engine 322. That is, in the game apparatus 10, the image included in the WEB page which is planarly displayed on the lower LCD 12 in the process of step S4 is again obtained from the WEB server 100.

When the CPU 311 obtains the image selected by the press-and-hold operation of the touch pen 28, the CPU 311 determines whether or not the image is a stereoscopically viewable image (step S135). Specifically, the CPU 311 analyzes a header (auxiliary information) of the image data 330, and determines whether or not the image represented by the image data 330 is a stereoscopically viewable image, based on whether or not a plurality of images are included in the image data 330. That is, the CPU 311 determines whether or not the image data 330 is composed of a plurality of (two) images.

For example, the MIME type of the image may be obtained from the WEB server 100 to determine whether or not the image is a stereoscopically viewable image. In this method, however, if the MIME type is not appropriately set (for example, if the subtype name of the MIME type is not appropriately set), the CPU 311 might fail to accurately determine whether or not the image is a stereoscopically viewable image. Therefore, in the present embodiment, the CPU 311 determines whether or not the image is a stereoscopically viewable image, based on the information in the header of the image data 330.

If the stereoscopically viewable image is a multipicture format stereoscopically viewable image, an individual image, which is different from an individual image as a head image, is included in the image data 330. Therefore, the process of determining whether or not the image is a stereoscopically viewable image may be performed based on presence/absence of the individual image (second image) other than the head image, instead of referring to the header of the image data 330.

When the CPU 311 determines that the image obtained in the process of step S134 is not a stereoscopically viewable image (NO in step S135), the CPU 311 planarly displays the obtained image on the upper LCD 22 (step S136). In step S136, the obtained image may be planarly displayed not on the upper LCD 22 but on the lower LCD 12.

On the other hand, when the CPU 311 determines that the image obtained in the process of step S134 is a stereoscopically viewable image (YES in step S135), the CPU 311 stereoscopically displays the obtained image on the upper LCD 22 (step S137) as described with reference to FIG. 6. Specifically, the CPU 311 causes the GPU 312 to perform a rendering process with a head image included in the image data 330 being a left-eye image and an individual image that follows the head image being a right-eye image, and then stereoscopically display the stereoscopically viewable image thus obtained on the upper LCD 22.

As described above, the CPU 311 appropriately identifies a stereoscopically viewable image, which should originally be displayed planarly on the lower LCD 12 based on the browser engine 322, as a stereoscopically viewable image based on the image display processing program 323, and causes the upper LCD 22 to stereoscopically display the image.

Accordingly, when the browser engine 322 does not have a function of appropriately identifying an image in a WEB page as a stereoscopically viewable image, and stereoscopically displaying the image, it is possible to appropriately identify the image as a stereoscopically viewable image and stereoscopically display the image. That is, it is possible to stereoscopically display the stereoscopically viewable image in the WEB page, without making a significant change to the browser engine 322.

Subsequently to the process of steps S136 or S137, as shown in FIG. 6B, the CPU 311 causes the lower LCD 12 to planarly display the selection screen including the button for storing the image and the button for returning to display of the WEB page (step S138).

Next, the CPU 311 determines whether or not storage of the image is instructed, based on whether or not an operation of selecting, with the touch pen 28, the button for storing the image (refer to FIG. 6B) has been performed on the touch panel 13 (step S139). When it is determined that storage of the image is instructed (YES in step S139), the CPU 311 stores the image displayed on the upper LCD 22 (step S140). Specifically, when the stereoscopically viewable image is displayed on the upper LCD 22 by the process of step S137, the CPU 311 stores the stereoscopically viewable image in the external data storage memory 45, for example. When the planarly viewable image is displayed on the upper LCD 22 by the process of step S136, the CPU 311 stores the planarly viewable image in the external data storage memory 45, for example.

After the process of step S140 is done or when the result of determination is that storage of the image is not instructed (NO in step S139), the CPU 311 determines whether or not an end instruction is issued, which ends the display of the image on the upper LCD 22 and returns the display to the WEB page (step S141). Specifically, the CPU 311 determines whether or not an operation of selecting, with the touch pen 28, the button for returning to display of the WEB page (refer to FIG. 6B) is performed on the touch panel 13. When the CPU 311 determines that no end instruction is issued (NO in step S141), the process returns to step S139. Conversely, when the CPU 311 determines that an end instruction is issued (YES in step S141), the process returns to step S4, and the WEB page is again displayed on the lower LCD 12.

In the present embodiment, the process of determining whether or not the set period of time has elapsed (step S131) and the process of determining whether or not the component at the touch position is an image (step S132) are executed by the image display processing program 323. However, these processes may be executed by the browser engine 322.

[Function and Effect of the Present Embodiment]

As described above, according to the present embodiment, an image included in contents of a WEB page is obtained anew from the WEB server 100, and if the image is a stereoscopically viewable image, the image is displayed on the upper LCD 22 as a stereoscopically viewable image. Accordingly, when a stereoscopically viewable image is included in the contents obtained from the WEB server 100, the stereoscopically viewable image can be appropriately stereoscopically displayed.

Further, in the present embodiment, when the user operates the touch pen 28 so that the coordinate point on the lower LCD 12, which is designated on the touch panel 13, satisfies a predetermined determination condition, an image included in the contents is obtained. When the image is a stereoscopically viewable image, it is stereoscopically displayed on the upper LCD 22. Therefore, it is possible to stereoscopically display the image only when the user performs an operation to stereoscopically display the image.

Further, in the present embodiment, the above-described determination condition is that the same coordinate point in an image on the lower LCD 12 on which the contents are displayed is continuously designated over a set period of time. Therefore, the user can easily view the image as a stereoscopically viewable image by performing, at a desired timing, a simple operation of holding the touch pen 28 without sliding the touch pen 28 or moving the touch pen 28 away from the touch panel 13 so that the same coordinate point in the image is continuously designated over the set period of time.

By the way, depending on the configuration of the game apparatus 10, an image in a WEB page cannot be easily obtained from the cache of the game apparatus 10 after the WEB page is planarly displayed. The configuration of the present embodiment, in which an image included in contents is obtained from a WEB server 100 which provides the contents, is suitably applicable to the above-described case.

Further, in the present embodiment, it is determined whether or not an obtained image is a stereoscopically viewable image, based on whether or not the image is composed of a plurality of images. Therefore, determination as to whether or not an image is a stereoscopically viewable image can be easily performed.

Further, in the present embodiment, when the obtained image is a stereoscopically viewable image, the image is displayed on the upper LCD 22 which is different from the lower LCD 12 on which the contents other than the stereoscopically viewable image are displayed. Therefore, the user can easily recognize that the obtained image is stereoscopically displayed on the screen as a stereoscopically viewable image.

### MODIFICATIONS

The present invention is not limited to the embodiment described above. The present invention may be implemented in, for example, the following manners. That is, in the above-described embodiment, the predetermined determination condition is that the same coordinate point in an image on the lower LCD 12 is continuously designated over a set period of time. However, the predetermined determination condition may be that a coordinate point is continuously designated in a predetermined range of an image on the lower LCD 12. In this case, the user performs, at a desired timing, a simple operation of continuously repeating “touch on” and “touch off” of the touch pen 28 so that the coordinate point in the predetermined range of the image is continuously designated, and thus the user can easily view the image as a stereoscopically viewable image.

Further, in the above-described embodiment, an image included in the contents is obtained when a coordinate point designated on the touch panel 13 on the lower LCD 12 satisfies the predetermined determination condition. However, an image included in the contents may be automatically obtained on condition that the contents are planarly displayed on the lower LCD 12, regardless of the coordinate point designated on the touch panel 13. Alternatively, an image included in the contents may be obtained on condition that any of the operation buttons 14A to 14L is pressed after the contents are planarly displayed on the lower LCD 12.

Further, in the above-described embodiment, an image included in contents is obtained from a WEB server 100 that provides the contents. However, an image included in contents may be obtained from the cache of the game apparatus 10.

Further, in the above-described embodiment, a WEB page is planarly displayed on the lower LCD 12, and an image that cannot be stereoscopically displayed is displayed on the upper LCD 22 while an image that can be stereoscopically displayed is displayed on the upper LCD 22. However, the WEB page and the images may be displayed on one screen. In this case, for example, a general WEB page including images is planarly displayed on the upper LCD 22, and the display of the WEB page is completed at a timing when an image as a stereoscopically viewable image is obtained, and the obtained image is stereoscopically displayed on the upper LCD 22. Alternatively, the display of the WEB page is completed at a timing when an image that cannot be stereoscopically displayed is obtained, and the obtained image is planarly displayed on the upper LCD 22.

Further, in the above-described embodiment, a series of process steps as described above is realized by using one game apparatus 10. However, the present invention is not limited thereto. The series of process steps as described above may be realized by a plurality of information processing apparatuses cooperating with each other. Specifically, the function of at least one of first obtaining means, first display control means, second obtaining means, first determination means, and second determination means may be realized by, for example, a server device on the network, different than the game apparatus 10. In this case, a system including the game apparatus 10 and the server device functions in the same manner as the game apparatus 10 described above.

Furthermore, in the above-described embodiment, the shape of the game apparatus 10, and the shapes, numbers, and mounting positions of the various operation buttons 14 and the touch panel 13 of the game apparatus 10 are only exemplary ones. Needless to say, the present invention may be realized by using other shapes, numbers, and mounting positions. Further, the order in which the process steps are performed, set values, threshold values used for the determinations, and the like, which are described above with reference to the flowcharts, are only exemplary ones. Needless to say, the present invention may be realized by using other order and values if the use of the order and values do not cause departure from the scope of the present invention.

Moreover, the display control program executed by the game apparatus 10 of the above-described embodiment may be supplied to the game apparatus 10 via a wired or wireless communication line as well as via a storage medium such as the external memory 44. Further, the display control program may be previously stored in a non-volatile storage device (the internal data storage memory 35 or the like) in the game apparatus 10. The information storage medium for storing the display control program may be, for example, a CD-ROM, a DVD, an optical disc-type storage medium similar to a CD-ROM or DVD, a flexible disk, a hard disk, a magneto-optical disk, and a magnetic tape, as well as a non-volatile memory. The information storage medium for storing the display control program may be a volatile memory for temporarily storing the display control program.

Moreover, in the above-described embodiment, the hand-held game apparatus 10 executes the display control program of the present invention to realize the present invention. However, a display control apparatus to which the present invention is applied may be a personal computer, or arbitrary hand-held electronic equipment such as a PDA (Personal Digital Assistant) or a mobile phone.

The present invention is applicable to, for example, a computer-readable storage medium having stored therein a display control program executed by a computer of a display control apparatus for displaying, on a screen, an image obtained from a server device such as a WEB server; a display control apparatus; a display control system; and a display control method.

While the invention has been described in detail, the foregoing description is in all aspects illustrative and not restrictive. It will be understood that numerous other modifications and variations can be devised without departing from the scope of the invention.

What is claimed is:

1. A computer-readable storage medium having stored therein a display control program executed by a computer of a display control apparatus for displaying, on a screen, an image obtained from a server device, wherein
the display control program causes the computer to function as:
first obtaining means for obtaining contents including an image from the server device;
first display control means for planarly displaying, on the screen, the contents obtained by the first obtaining means;
second obtaining means for obtaining an image included in the contents planarly displayed by the first display control means;
first determination means for determining whether or not the image obtained by the second obtaining means is a stereoscopically viewable image; and
second display control means for stereoscopically displaying the image on the screen when the first determination means determines that the obtained image is a stereoscopically viewable image.

2. The computer-readable storage medium having stored therein the display control program according to claim 1, wherein
the second display control means planarly displays the obtained image on the screen when the first determination means determines that the obtained image is not a stereoscopically viewable image.

3. The computer-readable storage medium having stored therein the display control program according to claim 1, wherein
the display control program causes the computer to further function as second determination means for determining whether or not a coordinate point, which is designated by coordinate input means on the screen where the contents are displayed, satisfies a predetermined determination condition, and
the second obtaining means obtains an image included in the contents when the second determination means determines that the predetermined determination condition is satisfied.

4. The computer-readable storage medium having stored therein the display control program according to claim 3, wherein
the second determination means determines, based on the coordinate point designated by the coordinate input means, whether or not a press-and-hold operation is performed onto the image on the screen where the contents are displayed, thereby determining whether or not the coordinate point designated by the coordinate input means satisfies the predetermined determination condition.

5. The computer-readable storage medium having stored therein the display control program according to claim 4, wherein
the predetermined determination condition is that a coordinate point is continuously designated over a set period of time, in a predetermined range of the image on the screen where the contents are displayed.

6. The computer-readable storage medium having stored therein the display control program according to claim 5, wherein
the first display control means scroll-displays the contents when the coordinate point designated by the coordinate input means gets out of the predetermined range of the image, within the set period of time.

7. The computer-readable storage medium having stored therein the display control program according to claim 3, wherein
the predetermined determination condition is that a coordinate point is continuously designated in a predetermined range of the image on the screen where the contents are displayed.

8. The computer-readable storage medium having stored therein the display control program according to claim 1, wherein
the second obtaining means obtains an image included in the contents, from a server device which has provided the first obtaining means with the image included in the contents.

9. The computer-readable storage medium having stored therein the display control program according to claim 1, wherein
the second obtaining means obtains an image included in the contents which have already been obtained by the first obtaining means, again from a server device which has provided the first obtaining means with the image included in the contents.

10. The computer-readable storage medium having stored therein the display control program according to claim 1, wherein
the first determination means determines whether or not an image obtained by the second obtaining means is a stereoscopically viewable image, based on whether or not the image obtained by the second obtaining means is composed of a plurality of images.

11. The computer-readable storage medium having stored therein the display control program according to claim 1, wherein
the screen includes a first screen capable of planarly viewable display and a second screen capable of stereoscopically viewable display, and
the first display control means performs planarly viewable display by using the first screen, and the second display control means performs stereoscopically viewable display by using the second screen.

12. The computer-readable storage medium having stored therein the display control program according to claim 1, wherein
the second display control means stereoscopically displays an image included in the contents, which has been obtained by the second obtaining means, in a size larger than the image included in the contents displayed by the first display control means.

13. The computer-readable storage medium having stored therein the display control program according to claim 1, wherein
the display control program causes the computer to further function as storage control means for storing, in storage means, at least a stereoscopically viewable image which is stereoscopically displayed by the second display control means, according to a user input.

14. A display control apparatus for displaying, on a screen, an image obtained from a server device, the display control apparatus comprising:
first obtaining means for obtaining contents including an image from the server device;
first display control means for planarly displaying, on the screen, the contents obtained by the first obtaining means;
second obtaining means for obtaining an image included in the contents planarly displayed by the first display control means;
first determination means for determining whether or not the image obtained by the second obtaining means is a stereoscopically viewable image; and
second display control means for stereoscopically displaying the image on the screen when the first determination means determines that the obtained image is a stereoscopically viewable image.

15. A display control system for displaying, on a screen, an image obtained from a server device, the display control system comprising:
first obtaining means for obtaining contents including an image from the server device;
first display control means for planarly displaying, on the screen, the contents obtained by the first obtaining means;
second obtaining means for obtaining an image included in the contents planarly displayed by the first display control means;
first determination means for determining whether or not the image obtained by the second obtaining means is a stereoscopically viewable image; and
second display control means for stereoscopically displaying the image on the screen when the first determination means determines that the obtained image is a stereoscopically viewable image.

16. A display control method for displaying, on a screen, an image obtained from a server device, the display control method comprising the steps of:
obtaining contents including an image from the server device;
planarly displaying the obtained contents on the screen;
obtaining an image included in the contents planarly displayed;
determining whether or not the obtained image is a stereoscopically viewable image; and
stereoscopically displaying the image on the screen when it is determined that the obtained image is a stereoscopically viewable image.
